(19) United States
(12) Patent Application Publication
(10) Pub. No.: US 2005/0039380 A1
(43) Pub. Date: Feb. 24, 2005

(54) Duplex lash insect swatter

(76) Inventor: Francis Luca Conte, Swampscott, MA (US)

Correspondence Address: FRANCIS L CONTE, 6 PURITAN AVENUE, SWAMPSCOTT, MA, 01907, US

(21) Appl. No.: 10/643,288

(22) Filed: Aug. 20, 2003

(51) Int. Cl. A01M 3/02

(52) U.S. Cl. 43/137

(57) ABSTRACT

An insect swatter includes an elongate rod with an elastic lash fixedly joined to a distal end thereof. The lash incudes a pair of annular bands knotted together for being stretched from the rod distal end to adjacent a proximal end of the rod so that release of the lash results in spontaneous contraction thereof for swatting the insect. In an exemplary embodiment, the swatter is in the form of a pistol, with the lash extending from the distal end of the rod to a latch operated by a trigger. Aiming the rod toward the insect and pulling the trigger releases the lash for swatting the insect.

The present invention relates generally to insect exterminators, and, more specifically, to an insect swatter.

### BACKGROUND OF THE INVENTION

A typical insect swatter, commonly referred to as a fly swatter, has a long handle with a proximal end configured for being gripped by a person, and a distal end at which is secured a generally rectangular, perforated wire or plastic mesh. In operation, the swatter is manually moved through the air for striking the insect with the mesh. However, the swatter must be moved very quickly in order to swat fast-reacting flies for example, or the fly will escape. The relatively large swatter mesh is apparently detectable by the insect either through its vision or by sensing the air being displaced as the mesh is moved.

If the swatter is moved quickly enough, the insect can be stricken which typically results in an offensive stain being created upon squashing of the insect.

An improved insect swatter is disclosed in U.S. patent application Ser. No. 08/331,851, filed Oct. 31, 1994, still pending. That insect swatter utilizes a long rubber band attached to the distal end of a long gun barrel or rod that can be stretched to a trigger latch at the opposite end of the rod at a handgrip.

Since the lash is elastic, it is able to store energy when stretched, and release that energy against the insect when it contracts during the whipping process. The elasticity of the lash also affects the effective striking range of the lash.

Continued development testing of the insect swatter has examined the effectiveness of the swatter, and uncovered problems therewith.

For example, short and stiff elastic lashes are not preferred since they have limited range and limited, if not impractical, ability to swat insects before detection. Long and resilient elastic lashes, on the other hand, have greater striking range, yet less available swatting energy, and are significantly weaker.

Furthermore, weak elastic lashes are more readily worn or damaged than strong lashes, and more quickly lose their swatting effectiveness. The typical rubber composition used in commercially available rubber bands is subject to environmental degradation which reduces the resiliency or stiffness of the bands, and the effectiveness thereof.

In view of these competing affects it is not practical to optimize elastic lash selection by merely choosing a band length and cross section for the specific size of the intended rod. And, custom made bands merely add to the cost of the swatter, and reduce the convenience thereof.

Accordingly, it is desired to provide an insect swatter requiring reduced skill for its use, reducing stains from the successful swatting of the insect, and including a simple and effective elastic lash.

### SUMMARY OF THE INVENTION

An insect swatter includes an elongate rod with an elastic lash fixedly joined to a distal end thereof. The lash incudes a pair of annular bands knotted together for being stretched from the rod distal end to adjacent a proximal end of the rod so that release of the lash results in spontaneous contraction thereof for swatting the insect. In an exemplary embodiment, the swatter is in the form of a pistol, with the lash extending from the distal end of the rod to a latch operated by a trigger. Aiming the rod toward the insect and pulling the trigger releases the lash for swatting the insect.

### BRIEF DESCRIPTION OF THE DRAWINGS

The invention, in accordance with preferred and exemplary embodiments, together with further objects and advantages thereof, is more particularly described in the following detailed description taken in conjunction with the accompanying drawings in which:

FIG. 1 is an elevational view of a hand-held insect swatter in accordance with one embodiment of the present invention.

FIG. 2 is an elevational, partly sectional enlarged view of the insect swatter illustrated in FIG. 1 showing a trigger and cooperating latch in cocked positions.

FIG. 3 is an enlarged, partly sectional view of the insect swatter illustrated in FIG. 2 showing a trigger and cooperating latch in fired positions.

FIG. 4 is a top, partly sectional view of the insect swatter illustrated in FIG. 2 and taken generally along line 4-4.

FIG. 5 is an isometric view of a duplex lash in accordance with an exemplary embodiment.

FIG. 6 is a top view of the insect swatter illustrated in FIG. 1 having the duplex lash of FIG. 5 installed therein.

### DESCRIPTION OF THE PREFERRED EMBODIMENT(S)

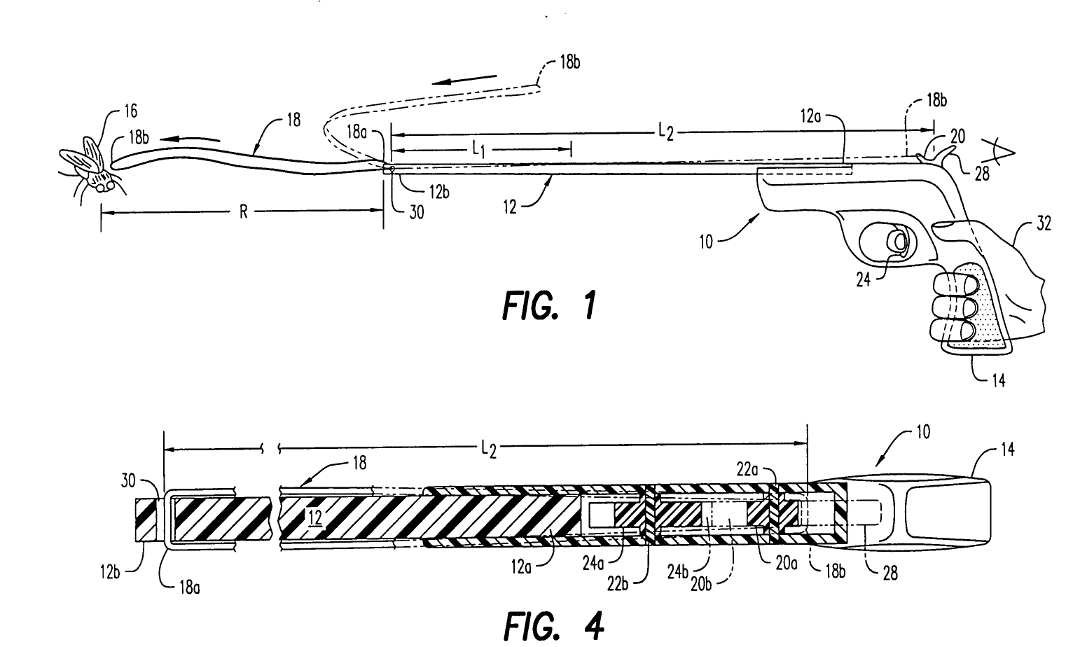

Illustrated in FIG. 1 is an exemplary embodiment of an insect swatter 10 in the exemplary form of a pistol, although in other embodiments it may be in the form of a rifle or other suitable configurations. The swatter 10 includes an elongate rod 12 which may be solid as illustrated, or hollow if desired, and may have any suitable cross section such as circular for example.

The rod 12 has a proximal end 12a for being hand-held, and in the exemplary embodiment illustrated in FIG. 1 a gun-type handgrip 14, in the exemplary form of a pistol handgrip, is suitably fixedly joined to the rod proximal end 12a. In alternate embodiments, the handgrip 14 could be a rifle handgrip with a cooperating shoulder stock for example. The handgrip 14 provides a convenient manner for hand holding the elongate rod 12 and aiming it toward an insect 16, such as a fly for example.

The rod 12 has a distal end 12b, opposite to the proximal end 12a, which is aimed during operation at or toward the insect 16. An elastic lash 18 in the exemplary form of a conventional annular rubber band has a proximal end 18a fixedly joined to the rod distal end 12b which retains the lash 18 to the rod 12. The lash 18 has an opposite, distal end 18b which is used for swatting or killing the insect 16.

As shown in FIG. 1, the lash 18 is preferably so sized or so dimensioned for being stretched from the rod distal end 12b to adjacent the rod proximal end 12a so that release of the lash distal end 18b spontaneously contracts or “fires’ the lash 18 for swatting or whipping the lash distal end 18b against the insect 16.

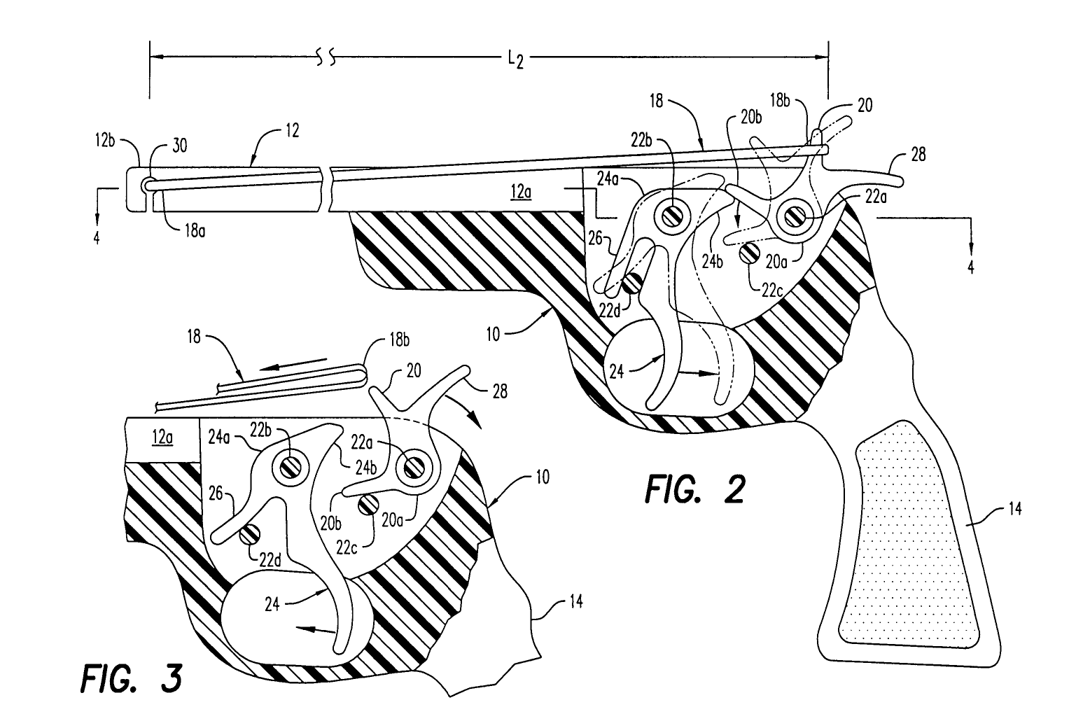

An exemplary method of using the swatter 10 includes manually stretching the lash 18 by pulling the distal end 18b thereof generally parallel to the rod 12 and adjacent to the rod proximal end 12a which stores energy in the lash 18. This is shown in phantom line in FIG. 1 and in solid line in FIG. 2. By aiming the rod distal end 12b at the insect 16 and within reach or striking range R of the whipping lash 18, and then releasing the lash distal end 18b, the lash 18 spontaneously contracts for swatting the lash distal end 18b against the insect 16, with the kinetic energy released by the lash 18 being sufficient for killing or severely maiming the insect 16.

In its simplest form, the rod 12 and the attached lash 18 form a whip. The rod 12 is used for manually aiming the swatter 10 at the insect 16 so that the energy stored in the stretched lash 18 causes the lash 18 to accelerate from the rod proximal end 12a, generally parallel along the rod 12 toward the rod distal end 12b, and continue to travel in the same direction away from the rod distal end 12b for impacting the insect 16.

The whipping action of the lash 18 is shown in three positions in FIG. 1 and will carry the lash 18 along the line-of-sight formed by the rod 12 aimed at the insect 16 for allowing easy and accurate swatting thereof. As long as the rod distal end 12b is positioned within the whipping range R of the lash 18, the insect 16 may be effectively swatted.

The lash 18, like a whip cord, is completely flexible, not rigid, but unlike a whip cord, it is also elastically stretchable. It may have any suitable cord-like configuration, such as the rubber band disclosed in the preferred embodiment. In this way, energy may be conveniently stored in the stretched lash 18 by stretching it in one direction, and then the energy is released which carries the lash 18 along the line-of-sight in the direction opposite to the stretching direction thereof to accurately hit the insect 16. The striking energy includes the energy stored in the stretched lash 18, as well as any additional energy due to the whipping effect. The lash 18 is therefore not an expendable, one-shot projectile, but remains with the rod 12 for repeated use.

Since the lash 18 itself stores the energy used for moving the lash 18, it is relatively easy to use and does not require the fast hand action required of a typical fly swatter. Whipping of the lash 18 is spontaneous and occurs within a fraction of a second for quickly swatting the insect 16 well before its ability to react thereto. Furthermore, the lash 18 is relatively small as compared to conventional fly swatters, and is less visible by the insect 16 compared thereto, and moves less air than a conventional fly swatter which reduces the ability for the insect 16 to sense the striking action of the lash 18.

Yet further, the energy imparted by the whipping lash 18 against the insect 16 is confined to a very small point which in most cases immediately kills the insect 16 with little or no stain therefrom due to the striking thereof.

In its simplest form, the lash 18 may be manually stretched and held at its distal end 18b adjacent to the rod proximal end 12a and then manually released for swatting the insect 16. However, in order to add additional convenience and accuracy in using the swatter 10, it preferably further includes a latch or hook 20 as shown in more particularity in FIG. 2.

The latch 20 may simply be in the form of a straight, smooth bar having an enlarged proximal end 20a through which extends a latch pin 22a for pivotally joining the latch 20 to the handgrip 14 adjacent to the rod 5 proximal end 12a for releasably latching the lash distal end 18b thereto. The latch 20 is joined to the top of the handgrip 14 in a suitable cavity therein.

The latch 20 is shown in FIG. 2 in a first or cocked position wherein the latch 20 extends generally perpendicularly upwardly from the rod 12, or from its longitudinal centerline axis, for retaining or latching the lash distal end 18b thereto. The latch 20 in its cocked position is preferably inclined slightly rearwardly away from the rod 12 to ensure that the lash distal end 18b does not inadvertently slip therefrom prior to firing.

Means including a trigger 24 are operatively joined to the latch 20 for selectively releasing the latch 20 from its cocked position upon pulling the trigger 24 rearwardly to release the lash distal end 18b for swatting the insect 16 therewith. Shown also in FIG. 2 is the trigger 24 having an enlarged proximal end 24a which is pivotally joined to the handgrip 14 by a trigger pin 22b extending therethrough so that the trigger 24 may be pivoted between the first or cocked position thereof holding the latch 20 in its cocked position, and a second or fired position illustrated in FIG. 3 releasing the latch 20 for being pivoted to its fired position also shown in FIG. 3.

In its fired position, the latch 20 is inclined forwardly toward the rod distal end 12b for allowing the lash distal end 18b to slip or slide off the latch 20 as shown in FIG. 3 for spontaneously contracting the lash 18 toward the rod distal end 12b. The trigger 24 is operatively joined to the latch 20 by any suitable means for releasing the latch 20 to pivot from its cocked position to its fired position upon pulling of the trigger 24.

In an exemplary embodiment, the latch 20 includes an elongate latch cam 20b which extends generally radially outwardly from the latch proximal end 20a and the latch pin 22a toward the trigger proximal end 24a. And, the trigger 24 includes a complementary, elongate trigger cam 24b extending generally radially outwardly from the trigger proximal end 24a and trigger pin 22b therethrough, with the two cams 20b,24b being engaged in the cocked positions for preventing rotation of the latch 20 as shown in FIG. 2.

When the trigger 24 is pulled rearwardly as shown in FIG. 3, the trigger cam 24b slides past the latch cam 20 which allows the stretched lash 18 to pull the latch 20 into its fired position by rotating it counterclockwise, which in turn then allows the lash distal end 18b to slip from the latch 20 and be released therefrom. A suitable latch stop pin 22c is joined to the handgrip 14 adjacent to the latch pin 22a for limiting the counterclockwise rotation of the latch 20 by abutting the latch cam 20b as shown in FIG. 3.

As shown in FIGS. 2 and 3, a trigger return spring 26 in the exemplary form of a flexible cantilever is operatively joined between the trigger 24 and the handgrip 14, with the spring 26 being positioned for providing a returning force on the trigger 24 to return the trigger 24 to its cocked position upon finger release thereof. In the exemplary embodiment illustrated in FIGS. 2 and 3, the spring 26 extends integrally from the trigger proximal end 24a and generally parallel to the upper portion of the trigger 24 itself, and defines a space therebetween in which is disposed a stationary trigger stop pin 22d which is fixedly joined to the handgrip 14.

In FIG. 2, the trigger 24 is in its cocked position with the return spring 26 being disposed on one side of the trigger stop pin 22d in an undeflected position for holding the trigger 24 in its forwardmost position abutting the opposite side of the trigger stop pin 22d. Upon pulling the trigger 24 rearwardly, which is shown in phantom line in FIG. 2 and in solid line in FIG. 3, the spring 26 elastically flexes against the trigger stop pin 22d as the trigger 24 is pulled rearwardly which allows the cooperating latch and trigger cams 20b, 24b to disengage so that the elastic lash 18 may pivot the latch 20 counterclockwise and be released therefrom. When the trigger 24 is released, the return force provided by the spring 26 causes the trigger 24 to rotate clockwise until the trigger 24 abuts the stop pin 22d.

Other conventional types of return springs may be used such as tension or compression springs disposed on suitable sides of the trigger 24 to provide the same returning force if desired.

In the exemplary embodiment illustrated in FIGS. 2 and 3, the latch 20 preferably also includes a conventional thumbgrip 28 integrally joined thereto and extending rearwardly, generally perpendicularly therefrom for manually returning or cocking the latch 20 to its cocked position. After the lash 18 is fired, the latch 20 rotates counterclockwise until the latch stop pin 22c prevents further rotation thereof. With or without releasing the trigger 24, the thumbgrip 28 may be pressed downwardly for rotating the latch 20 clockwise to return it to its cocked position.

If the trigger 24 is in its released position, cocking of the thumbgrip 28 causes the latch cam 20b to temporarily displace the trigger 24 upon sliding against the underside of the trigger cam 24b. When both the latch 20 and the trigger 24 are returned to their cocked positions, the lash 18 may be reloaded or re-affixed to the latch 20 in preparation for the next shot thereof.

As indicated above, the lash 18 is in the exemplary form of a rubber band, with the lash proximal end 18a forming a first loop as shown in more particularity in FIG. 4, and the lash distal end 18b forming an opposite, second loop positionable around the latch 20 as shown in FIGS. 2-4 for being simply retained or latched thereby.

As shown in FIG. 2, the rod distal end 12b preferably includes a keyhole slot 30 sized for receiving the lash proximal end loop 18a therethrough for retaining the lash 18 to the rod 12 without allowing unintended disconnection therefrom when the lash 18 is fired. The keyhole slot 30 includes an enlarged cylindrical portion extending laterally through the middle of the rod distal end 12b, and a rectangular portion which faces or is open downwardly. The rectangular portion is preferably narrower than the unstretched cross section of the lash 18 to prevent its passage therethrough, with the cylindrical portion being suitably larger than the undistorted cross section of the lash 18 for loosely fixedly joining the lash 18 to the rod 12.

In order to replace a worn or broken lash 18, the worn lash 18 may be suitably removed from the keyhole slot 30, with the replacement lash 18 being initially manually stretched so that its cross section is narrower than the rectangular portion of the keyhole slot 30 for allowing it to be inserted through the rectangular portion and into the cylindrical portion of the keyhole slot 30 wherein it is retained after being unstretched.

As shown in FIG. 2, the latch 20 extends upwardly from the handgrip 14 or generally perpendicularly to the longitudinal centerline of the rod 12, and the keyhole slot 30 is open downwardly in the direction opposite to the upward extension of the latch 20. In this way, the lash 18 is inclined slightly upwardly from the keyhole slot 30 to the latch 20 when latched thereto which provides good retention of the lash 18 to the latch 20 in its cocked position while also providing good aiming capability along the longitudinal axis of the rod 12.

Accordingly, in order to use the swatter 10, the thumbgrip 28 is cocked to position the latch 20 in its cocked position, with the trigger 24 also being positioned in its cocked position as shown in FIG. 2 for example. Stretching of the lash 18 is manually accomplished by the operator or user of the swatter 10 by pulling the lash distal end 18b generally parallel to the rod 12 and adjacent to the rod proximal end 12a for latching the lash distal end loop 18b around the latch 20.

As shown in FIG. 1, the handgrip 14 is gripped by the hand 32 of the operator or user to aim the swatter 10 along its rod 12 at the insect 16, with the rod distal end 12b being correspondingly aimed at the insect 16 with the fired lash 18 being within striking range R thereof. Upon pulling the trigger 24, the latch 20 is released and spontaneously contracts or fires for swatting the insect 16 with the lash distal end 18b. The lash 18 may be reloaded and refired as often as desired until the lash 18 wears out or breaks. In that case, the lash 18 is readily replaced.

As shown in FIG. 1, the lash 18 has an unstretched free length L1. The rod 12 and cooperating latch 20 have or define a collective cocked length L2 measured linearly between the keyhole slot 30 and the latch 20 in its cocked position. The cocked length L2 is preferably selected for stretching the lash 18 to about its maximum stretched length without breaking thereof to maximize the potential energy therein.

In a preferred embodiment, the cocked length L2 is at least three times the lash unstretched length L1 which not only provides substantial striking energy within the lash 18, but also provides a substantial amount of striking range R which is the distance between the insect 16 and the rod distal end 12b. Of course, the striking range R is at least as large as the lash unstretched length L1, and in actuality it is larger than the unstretched length L1 since the kinetic energy in the striking lash 18 causes the lash 18 to stretch in the opposite direction from the rod 12 toward the insect 16 at which it is aimed.

In an exemplary embodiment of the present invention, the lash 18 may be in the form of a common rubber band having an unstretched length L1 of 17 cm with a 2 mm square cross section. The cocked or stretched length L2 of the lash 18 is about 60 cm which provides a substantial striking range R for the swatter of about 38 cm, which is greater than twice the unstretched length L1.

The swatter 10 may be manufactured from any suitable material. In the exemplary embodiment illustrated in the Figures, all components of the swatter 10 may be formed of conventional molded plastic. Plastic is preferred for the trigger 24 since the integral return spring 26 may be formed of suitably thin plastic for providing an effective elastic return force for the trigger 24. In other embodiments, the rod 12 and handgrip 14 may be formed of wood or metal as desired.

Although the swatter 10 is illustrated in the Figures as being in the form of a long barreled pistol, it may take any suitable form including that of a rifle or other analogous shooting implement so that the stretched lash 18 may be suitably aimed at the insect 16 within an effective striking range R thereof for ensuring undetected swatting thereof.

As indicated above, continued development of the insect swatter has uncovered problems in optimizing the exemplary rubber band used for the lash. If the lash is too short or too stiff, the effective striking range is too small, and the ability to swat insects is impaired.

If the lash is too long or too resilient, the striking range may be extended, but at the expense of the ability to impart sufficient energy for the whipping action and striking effectiveness.

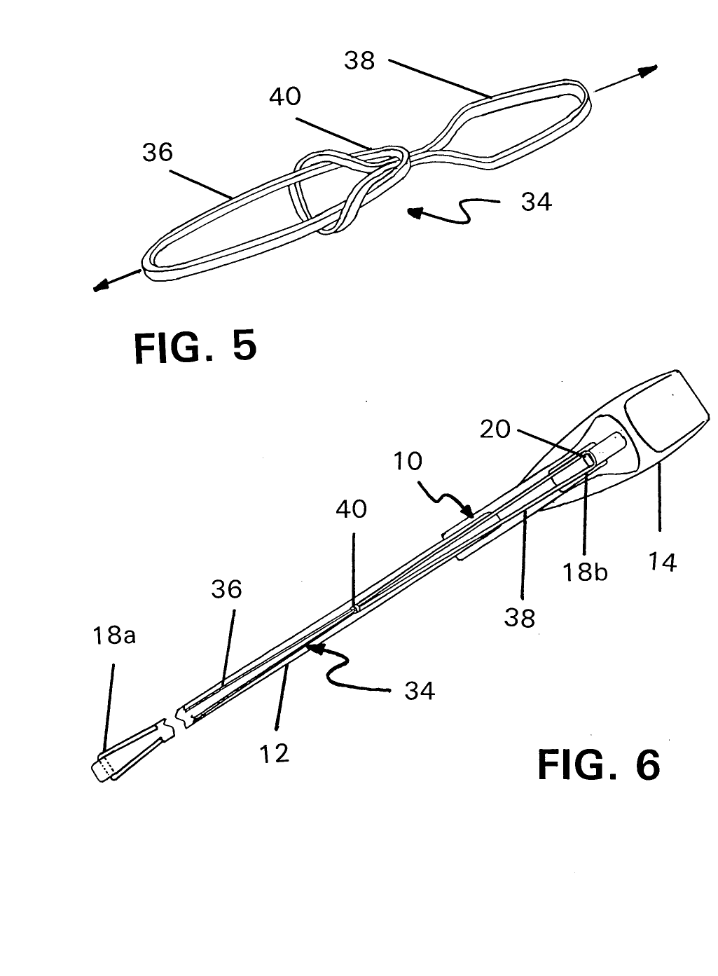

Accordingly, FIGS. 5 and 6 illustrate another embodiment of the insect swatter which is identical to the embodiment shown in FIGS. 1-4, except for the introduction of an improved duplex elastic lash 34 replacing the single elastic lash 18. The lash 34 includes a pair of annular rubber bands 36,38 joined together at a knot 40 therebetween collectively forming a unitary assembly.

The individual rubber bands 36,38 may have any conventional composition, and are preferably standard rubber bands commercially available at common stationery supply stores. In this way, the bands need not be custom made to size, cross section, and material composition for the specifically sized rod 12, which reduces cost thereof; and makes replacement bands readily available.

In the preferred embodiment, the two bands 36,38 are identical in size, cross section, and material composition, and have equal lengths to position the knot midway between both the nominal, unstretched combined length thereof, and the cocked length shown in FIG. 6.

The two bands 36,38 are shown being assembled together in FIG. 5, with the first band 36 being intertwined in the second band 38 to form a conventional square knot therebetween. By stretching apart the two bands, the size of the knot is automatically reduced to about the size of the cross section of the two bands together. The resulting lash 34 therefore has the general appearance of a figure-8, with the knot 40 being at the middle thereof.

The duplex lash 34 illustrated in FIGS. 5 and 6 may be directly substituted for the single lash 18 illustrated in FIGS. 1-4, and is usable in the same manner as described above. The only difference in configuration is the introduction of the knot 40 at junction of the two bands; and the method of operation remains the same.

The bands 36,38 may have a standard size such as being about 9 cm long with a rectangular cross section of about 1.6 mm by 3.2 mm. The combined length of the knotted bands is about 18 cm, which is about the same as the 17 cm length of the exemplary single lash 18. And, both the original lash 18 and the duplex lash 34 are stretchable to about 60 cm, but with correspondingly different stiffnesses which affects their whipping performance.

As shown in FIG. 6, compared with FIG. 2, the first band 36 includes the distal end 18a of the combined lash 34, which forms the first loop disposed through the keyhole. The second band 38 includes the proximal end 18b of the combined lash 34, which forms the second loop positionable around the latch 20 for being retained thereby. When the lash 34 is stretched to the cocking position, the knot 40 is positioned atop the rod 12 and is readily propelled forwardly with the two bands without obstruction by the rod itself.

The relatively small first band 36 terminating in the knot 40 uses the rod itself for guidance during swatting, and the second band 38 follows the travel of the knot 40 from which it extends. The duplex lash therefore enjoys accuracy of direction or firing, without the knot 40 providing any obstruction in travel.

A particular advantage of the two bands joined together is their improved cooperation not available in individual bands alone, irrespective of size. Each rubber band is a spring having a respective spring constant or stiffness. By joining together in series end-to-end the two bands 36,38, the resulting spring constant or stiffness thereof is the reciprocal of the sum of the reciprocals of the individual stiffnesses. In other words for identical rubber bands 36,38 joined in series, the combined stiffness thereof is one-half the stiffness of either band.

Accordingly, the combined two bands 36,38 enjoy double their individual lengths, yet with half the spring rate or stiffness of each band. The two bands can also be stretched to double the stretching length of each band alone.

When the duplex lash 34 is assembled with the insect swatter 10 as shown in FIG. 6, the large cocked length is readily achieved, without excessive stretching or stiffness. It would be impossible to stretch a single band 36 or 38 to the large cocking length, and the striking range of such single band would be severely limited.

Each of the two bands 36,38 may be stretched to substantially its maximum capability, with the combined stiffness thereof being half that of each band alone. The inherent resilience or elasticity of each of the bands combines upon firing of the swatter. The initially stretched bands contract spontaneously as they are hurled forward by the potential energy stored therein corresponding to the respective stiffness thereof, and the whipping reaction re-stretches the bands in the forward direction for achieving a large striking range, with substantial impacting energy. The striking range is therefore extended due to the half stiffness of the combined bands.

Accordingly, the joining together of the two bands in a string improves performance of the insect swatter, not possible by an individual band alone; nor possible with two bands joined together in parallel. The combined stiffness of two bands in parallel is twice that of the individual bands, and without increased striking range; and does not enjoy the benefits of the differently operating series bands.

Although two identical bands are preferred, it is contemplated that two differently sized bands could be used to advantage in forming the resulting duplex lash. And, it is also contemplated that three or more bands could be joined together in series, if desired.

An additional advantage of using multiple bands in series is that the individual bands could be formed differently from each other to have different size, cross section, and material composition.

Development testing of the duplex lash configuration supports its extraordinary effectiveness in swatting and killing ordinary house flies, typically with one shot due to the easy aiming of the device. The use of the trigger adds aiming accuracy and spontaneity to the firing process not available in the manual firing of the lash without the trigger.

The enhanced striking range of the series bands improves effectiveness of the swatter, with a suitable amount of stiffness in the two bands for whipping the lash and imparting commensurate swatting energy even for the biggest of ordinary house flies.

And, the use of ubiquitous rubber bands eliminates the need for special size lashes or custom order lashes, and permits acceptable swatter performance by the simple knotting together of two ordinary rubber bands.

While there have been described herein what are considered to be preferred and exemplary embodiments of the present invention, other modifications of the invention shall be apparent to those skilled in the art from the teachings herein, and it is, therefore, desired to be secured in the appended claims all such modifications as fall within the true spirit and scope of the invention.

Accordingly, what is desired to be secured by Letters Patent of the United States is the invention as defined and differentiated in the following claims, in which I claim:

1. An insect swatter comprising:
an elongate rod having a proximal end for being hand-held, and an opposite distal end for being aimed at an insect; and
an elastic lash including a pair of annular rubber bands joined together at a knot therebetween, and having a proximal end fixedly joined to said rod distal end, and an opposite distal end sized for being elastically stretched from said rod distal end to adjacent said rod proximal end so that release of said lash distal end spontaneously contracts said lash for swatting said lash distal end against said insect.

2. A method of using the swatter of claim 1 comprising:
stretching said lash by pulling said distal end thereof generally parallel to said rod and adjacent to said rod proximal end, and placing said knot mediate said rod;
aiming said rod distal end at said insect; and
releasing said lash distal end to spontaneously contract said lash for swatting said lash distal end against said insect.

3. A swatter according to claim 1 further comprising:
a latch pivotally joined adjacent to said rod proximal end for releasably latching said lash distal end; and
means for selectively releasing said latch to release said lash distal end for swatting said insect therewith.

4. A method of using the swatter of claim 3 comprising:
stretching said lash by pulling said distal end thereof generally parallel to said rod and adjacent to said rod proximal end, and placing said knot mediate said rod;
latching said lash distal end to said latch;
aiming said rod distal end at said insect; and
releasing said latch for spontaneously contracting said lash for swatting said insect with said distal end thereof.

5. A swatter according to claim 3 further comprising:
a gun handgrip fixedly joined to said rod proximal end;
said latch being pivotally joined to said handgrip; and
wherein said latch releasing means includes a trigger operatively joined to said latch for releasing said latch upon pulling said trigger.

6. A method of using the swatter of claim 5 comprising:
stretching said lash by pulling said distal end thereof generally parallel to said rod and adjacent to said rod proximal end, and placing said knot mediate said rod;
latching said lash distal end to said latch;
gripping said handgrip to aim said rod distal end at said insect; and
pulling said trigger to release said latch to spontaneously contract said lash for swatting said insect.

7. A swatter according to claim 5 wherein:
said rod distal end includes a keyhole slot; and
a first one of said rubber bands includes said lash proximal end forming a first loop disposed through said keyhole slot for fixedly joining said lash to said rod, and a second one of said rubber bands includes said lash distal end forming a second loop positionable around said latch for being retained thereby.

8. A method of using the swatter of claim 7 comprising:
stretching said lash by pulling said lash second loop generally parallel to said rod and adjacent to said rod proximal end, and placing said knot mediate said rod;
latching said lash second loop around said latch;
gripping said handgrip to aim said rod distal end at said insect; and
pulling said trigger to release said latch to spontaneously contract said lash for swatting said insect.

9. A swatter according to claim 7 wherein:
said latch extends upwardly from said handgrip;
said keyhole slot is open downwardly in a direction opposite to said upward extension of said latch; and
said lash is inclined upwardly from said keyhole slot to said latch when latched thereto, and said knot is positioned atop said rod.

10. A swatter according to claim 7 wherein:
said latch is pivotable between a cocked position wherein said latch extends generally perpendicularly to said rod for retaining said lash second loop thereon, and a fired position wherein said latch is inclined forwardly toward said rod distal end for allowing said lash second loop to slip off said latch for spontaneously contracting said lash; and
said trigger is operatively joined to said latch for releasing said latch to pivot from said cocked position thereof to said fired position thereof upon pulling said trigger.

11. A swatter according to claim 10 wherein said latch includes a thumbgrip extending generally perpendicularly therefrom for manually returning said latch to said cocked position thereof.

12. A swatter according to claim 11 further comprising:
a spring joined between said trigger and said handgrip;
said trigger being pivotable between a cocked position holding said latch in said cocked position thereof, and a fired position releasing said latch for pivoting said latch to said fired position thereof; and
said spring being positioned for providing a returning force on said trigger to return said trigger to said cocked position thereof upon release of said trigger.

13. A method of using the swatter of claim 12 comprising:
cocking said thumbgrip to position said latch into said cocked position thereof;
stretching said lash by pulling said lash second loop generally parallel to said rod and adjacent to said rod proximal end, and placing said knot mediate said rod;
latching said lash second loop around said latch;
gripping said handgrip to aim said rod distal end at said insect; and
pulling said trigger to release said latch to said fired position thereof to spontaneously contract said lash for swatting said insect.

14. A swatter according to claim 12 wherein:
said lash has an unstretched length;
said rod and latch have a collective cocked length measured between said keyhole slot and said latch in said cocked position thereof; and
said cocked length is selected for stretching said lash to about its maximum stretchable length without breaking thereof.

15. A swatter according to claim 14 wherein said cocked length is at least three times said lash unstretched length.

16. A swatter according to claim 14 wherein said first and second bands have equal lengths to position said knot midway between said cocked length thereof.

17. An insect swatter comprising:
an elongate rod having a slot at a distal end thereof;
an elastic lash configured in a figure eight with first and second knot-less loops at opposite ends, and joined together at a knot therebetween; and
said lash first loop is retained in said slot.

18. A swatter according to claim 17 further comprising:
a handgrip fixedly joined to a proximal end of said rod opposite from said distal end thereof;
a latch pivotally joined to said handgrip adjacent to said rod proximal end for releasably latching said lash second loop; and
a trigger operatively joined to said latch for releasing said latch upon pulling said trigger.

19. A swatter according to claim 18 wherein said lash includes a pair of annular rubber bands joined together in series at said knot, and having a collective spring rate equal to the reciprocal of the sum of the reciprocals of the spring rates of each of said bands.

20. A swatter according to claim 19 wherein said pair of rubber bands are identical in size, cross section, and material composition, and have equal lengths to position said knot midway between said first and second loops.
